(19) United States
(12) Patent Application Publication
(10) Pub. No.: US 2025/0282962 A1
(43) Pub. Date: Sep. 11, 2025

(54) 3D-printed products

(71) Applicant: LANXESS Deutschland GmbH, Cologne (DE)

(72) Inventors: Joerg-Dietrich Jentsch, Leverkusen (DE); Lars May, Langenfeld (DE); Hans-Ulrich Borst, Elsdorf (DE); Marvin Kischkewitz, Düsseldorf (DE)

(73) Assignee: LANXESS Deutschland GmbH, Cologne (DE)

(21) Appl. No.: 19/042,927

(22) Filed: Jan. 31, 2025

(30) Foreign Application Priority Data
Mar. 6, 2024 (EP) 24161676.2

(51) Int. Cl. C09D 7/41; B33Y 10/00; B33Y 70/00; C08K 5/3472; C09D 133/06

(52) U.S. Cl. CPC C09D 7/41; B33Y 70/00; C09D 133/062; B33Y 10/00; C08K 5/3472

(57) ABSTRACT

The present invention relates to urethane-acrylate-resin-based 3D-printed products having a colour distance ΔE<20 from the L*a*b* coordinates for a colour number, beginning with “3”, of the RAL colour chart, comprising at least one red perinone dye to be selected from 8,9,10,11-tetrachloro-12H-phthaloperin-12-one and/or 14H-benz[4,5]isoquino[2,1-a]perimidin-14-one dissolved therein, to the use of said red perinone dyes for producing 3D-printed products having a colour distance ΔE<20 from the L*a*b* coordinates for a colour number, beginning with “3”, of the RAL colour chart by photopolymerization, and to a method for increasing the lightfastness and the colouristic properties of photopolymerizable urethane-acrylate-resin-based compositions and 3D-printed products based thereon by means of at least one red perinone dye to be selected from 8,9,10,11-tetrachloro-12H-phthaloperin-12-one and/or 14H-benz[4,5]isoquino[2,1-a]perimidin-14-one dissolved therein.

The present invention relates to urethane-acrylate-resin-based 3D-printed products having a colour distance ΔE<20 from the L*a*b* coordinates for a colour number, beginning with “3”, of the RAL colour chart, comprising at least one red perinone dye to be selected from 8,9,10,11-tetrachloro-12H-phthaloperin-12-one and/or 14H-benz[4,5]isoquino[2,1-a]perimidin-14-one dissolved therein, to the use of said red perinone dyes for producing 3D-printed products having a colour distance ΔE<20 from the L*a*b* coordinates for a colour number, beginning with “3”, of the RAL colour chart by photopolymerization, and to a method for increasing the lightfastness and the colouristic properties of photopolymerizable urethane-acrylate-resin-based compositions and 3D-printed products based thereon by means of at least one red perinone dye to be selected from 8,9,10,11-tetrachloro-12H-phthaloperin-12-one and/or 14H-benz[4,5]isoquino[2,1-a]perimidin-14-one dissolved therein.

### BACKGROUND OF THE INVENTION

Colour masterbatches contain colorants in dispersed or dissolved form. The colour or hue of a plastic product serves inter alia as a distinguishing feature for companies or for a particular product, as a protective component, as a safety feature or as a functional additive. Amorphous plastics such as polystyrene, polycarbonate, polymethyl methacrylate, etc., the transparency of which is to be preserved, necessitate the use of polymer-soluble dyes. In contrast to a pigment, a colorant provided for 3D printing by photopolymerization is preferably soluble in the plastic resin to be processed and not present in colloidal form.

3D printing is a method of additive manufacturing. This refers to a process in which a component is built up layer-by-layer based on digital 3D design data through the deposition of a material. “3D printing” is therefore used for the purposes of the present invention as a synonym for additive manufacture. Additive manufacture does however describe better that this is a production process significantly different from conventional, ablative manufacturing methods. Instead of milling a workpiece out of a solid block, for example, additive manufacturing builds components layer-by-layer from materials that are available for example in fine powder form. Various metals, plastics and composites are available as materials.

3D printing has meanwhile become established as a manufacturing method in numerous sectors and industries. In the construction of demonstration and functional prototypes, small and medium-sized production runs, and also increasingly in mass production, this process is impressing with advantages unachievable with other, conventional methods. For instance, product development and market launch can be significantly accelerated and product individualizations or functional integration can be achieved in a shorter time, and often at lower cost. For major original equipment manufacturers (OEMs) from a wide range of industries, additive manufacturing by 3D printing thus offers opportunities for market differentiation in respect of new customer benefits, potential for cost reductions, and sustainability goals. In 3D printing, 3D-printed products are printed by selectively bringing a material suitable for the corresponding printing technology into the desired shape layer-by-layer in an automated process. An original equipment manufacturer or OEM is a manufacturer of components or products that does not put said items on the retail market itself; in the automotive industry the term “OEM” is used synonymously with a vehicle manufacturer.

There are various 3D printing processes for plastics. These include processes in which the plastic is generated by curing only during printing. One embodiment is photopolymerization-based 3D printing in which a photo-curing resin liquid is applied layer-by-layer and, through the use of light, subjected to a photo-curing process/polymerization or a light-induced curing. The selective layer-by-layer curing of the liquid resin is effected by a spatially confined, precisely defined, computer-controlled exposure of the resin to light within a spectral range suitable for the initiation process of the photopolymerization. UV light in particular, visible light or infrared light are suitable. The photopolymerization-based 3D printing process according to the invention is preferably stereolithography (SLA) or digital light processing (DLP). In both 3D printing variants, the setup for the corresponding devices consists of a light source with which exposure to light from above or below is possible, so-called “top-down” or “bottom-up” printing, a resin reservoir, and a platform on which the layer-by-layer curing of the plastic resin to be used for the 3D printing takes place. In SLA 3D printing, the surface to be cured is exposed to light point-by-point by scanning with a laser beam; in the DLP process, the exposure takes place over the entire surface to be exposed, especially with an LCD (liquid crystal display) panel. During a typical printing operation, the printing platform is immersed in the resin in the resin reservoir while the exposure program runs and creates a layer. Repeated layer creation results ultimately in the 3D-printed product. In the SLA process, a stereolithography printer creates the 3D-printed product with a laser. A plastic solution that cures under UV light is applied for this. Corresponding 3D printers are referred to as SLA 3D printers or DLP 3D printers. A comparison of the two technologies and also suppliers of corresponding 3D printers can be found in the review article: 3Dnatives, Regina P. 8 Apr. 2021 at https://www.3dnatives.com/de/sla-vs-dlp-3d-druck-080420211/US 2011/0070976 A1 describes a golf ball consisting of a core, at least one layer enveloping the core and a fluorescent pigment colour layer to be applied to the surface of the outermost layer of the shell. The outermost layer may consist of a thermoplastic polyurethane material (Pandex® T8290 or Pandex® T8283). For the colour layer to be applied to the outermost layer, Solvent Red 149 (Sumiplast® Red HFG) and Solvent Red 150 (Sumiplast® HF4G) are used as red fluorescent anthraquinone dyes in the examples. The ball has excellent spin performance and durability, an appearance that is characterized by excellent visibility, style and luxuriousness and also excellent weather resistance.

US 2019/0201171 A1 discloses coloured, curable compositions for use in an additive manufacturing process in which the composition comprises the following: a curable resin composition comprising radiation-curable components, a photoinitiator and a dye composition comprising a dye D1 and a dye D2, where dye D1 has a light absorption maximum within the 400 to 530 nm wavelength range and dye D2 has a light absorption maximum within the 540 to 650 nm wavelength range. As an example, two anthraquinone dyes are used: C.I. Solvent Red 111, CAS No. 82-38-2 (dye 1) and C.I. Solvent Violet 13, CAS No. 81-48-1 (dye 2). It also describes an S30 3D printer (Rapid Shape GmbH, Heimsheim, Germany) that employs an LED light with a wavelength of 405 nm at an intensity of 50 mW/cm² for 11 sec per layer to be applied.

In addition to advantageous colour properties during and immediately after the process for producing a 3D-printed product by photopolymerization, the properties in use of such 3D-printed products must also be considered. The colorants used in the prior art mentioned above have proven unfavourable because of the changes in colour that occur in the 3D manufacturing process as a consequence of the exposure to light needed for the photopolymerization. Sensitivity to light/lightfastness is however a quality characteristic for coloured 3D-printed products produced by photopolymerization-based 3D printing. Fading or discoloration as far as browning of a 3D-printed product produced by photopolymerization-based 3D printing should as far as possible be avoided.

Moreover, during photopolymerization, preferably photopolymerization by the SLA or DLP process, colorants intended for 3D printing should retain their advantageous performance characteristics and must not impair or even prevent the curing/polymerization of the 3D-printed product. For the purposes of the present invention, advantageous performance characteristics in the dyes to be defined according to the invention for 3D printing are the establishment of a desired/defined hue and the establishment of a pure, brilliant colour.

The problem addressed by the present invention is therefore that of providing red dyes for 3D printing by photopolymerization, in particular by the SLA or DLP method, that, by virtue of their solubility in the plastic to be processed, permit a defined red hue to be established, remain lightfast during the printing process and also retain their colouristic properties by comparison with Solvent Red 111, as is used in US 2019/0201171 A1, this being described in the context of the present invention as an increase in the lightfastness and colouristic properties, to be determined according to DIN EN ISO 4892-2.

### Method for Evaluating Lightfastness

To determine the lightfastness of dyes for photopolymerization-based 3D printing, test specimens are produced for the purposes of the present invention in the form of a cuboid of coloured resin having the dimensions length=60 mm, width=40 mm and height=2 mm and having a dye concentration of 0.02% in the resin. These test specimens are then exposed to light (xenon lamp) in the print-fresh state for 95-100 h according to DIN EN ISO 4892-2 using a Xenotest Beta+device (Atlas Material Testing Technology GmbH, Linsengericht-Altenhaßlau, Germany). Lightfastness is evaluated colorimetrically by recording transmission spectra of the light-exposed test specimens with an X-Rite Ci7800 sphere spectrophotometer (X-Rite GmbH, Planegg-Martinsried, Germany), choosing the following settings: measurement geometry=d/8°; spectral interval=10 nm; spectral range=360-750 nm. From the transmission spectra obtained, the manufacturer's software for the sphere spectrophotometer then calculates the colorimetric data with the following settings: light source/observer=D65/10°; colour space=L*a*b*C*h°. The basis for the evaluation of lightfastness is the colour distances ΔE in the L*a*b*C*h° colour space between light-exposed test specimens and the corresponding unexposed test specimens. The greater the colour distance, the greater the change in colour impression brought about by exposure to light and thus the poorer the lightfastness. AE is classified on the basis of a comparison with other dyes of similar hue, so-called noninventive examples, for which the lightfastness in other uses, particularly in the bulk colouring of plastics, is generally evaluated as good according to the manufacturer's data.

### Method for Evaluating the Stability of Coloristic Properties

In order to establish the change in the spectral properties that determine the colouristic properties of a dye, the absorption spectra before and after light-induced curing of the investigated coloured resins are compared for the purposes of the present invention.

For this, the coloured resins produced as described in the above section “Method for evaluating lightfastness” are transferred to a quartz glass cuvette 1 cm in width and absorption spectra in transmission mode are recorded with the X-Rite Ci7800 instrument (X-Rite GmbH, Planegg-Martinsried, Germany) in the 360 to 750 nm wavelength range. These absorption spectra are then corrected for the absorbance of the corresponding uncoloured resin by performing the same measurement with the uncoloured resin. In analogous manner, the absorption spectra in transmission mode of the coloured test specimens are recorded and corrected and the spectra in each case normalized to the path length of the cuvette/of the investigated test specimen.

Finally, the similarity of the absorption spectra before and after 3D printing is calculated from the measured data by calculating the correlation coefficient R of the normalized absorption (spectral interval 10 nm). The greater the value for R, the greater the similarity of the absorption spectra and the more stable the colouristic properties of a dye intended for photopolymerization-based 3D printing and suitable for the purposes of the present invention.

### SUMMARY OF THE INVENTION

The solution to the problem and the subject matter of the present invention are 3D-printed products having a colour distance ΔE<20 from the L*a*b* coordinates for a colour number, beginning with “3”, of the RAL colour chart, based on photopolymerizable compositions comprising at least one urethane acrylate resin and at least one red perinone dye to be selected from 8,9,10,11-tetrachloro-12H-phthaloperin-12-one and/or 14H-benz[4,5]isoquino[2,1-a]perimidin-14-one dissolved therein.

The present invention also provides for the use of at least one red perinone dye to be selected from 8,9,10,11-tetrachloro-12H-phthaloperin-12-one and/or 14H-benz[4,5]isoquino[2,1-a]perimidin-14-one, present in dissolved form, for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number, beginning with “3”, of the RAL colour chart. The increase in lightfastness and in colouristic properties is measured by recording transmission spectra before and after light-induced curing of test specimens of correspondingly coloured urethane acrylate resins using a sphere spectrophotometer, then corrected for the absorbance of the corresponding uncoloured resin and normalized to the path length of the cuvette/of the test specimen to be investigated, and then finally the similarity of the absorption spectra is determined from the measured data before and after 3D printing by calculating the correlation coefficient R of the normalized absorbance.

The invention further relates to a method for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number, beginning with “3”, of the RAL colour chart by dissolving at least one red perinone dye to be selected from 8,9,10,11-tetrachloro-12H-phthaloperin-12-one and/or 14H-benz[4,5]isoquino[2,1-a]perimidin-14-one in the urethane acrylate resin. The increase in lightfastness and in colouristic properties is measured by recording transmission spectra before and after light-induced curing of test specimens of correspondingly coloured urethane acrylate resins using a sphere spectrophotometer, then corrected for the absorbance of the corresponding uncoloured resin and normalized to the path length of the cuvette/of the test specimen to be investigated, and then finally the similarity of the absorption spectra is determined from the measured data before and after 3D printing by calculating the correlation coefficient R of the normalized absorbance.

Finally, the invention also relates to a method for the additive manufacture of 3D-printed products having a colour distance ΔE<20 from the L*a*b* coordinates for a colour number, beginning with “3”, of the RAL colour chart by employing urethane-acrylate-resin-based compositions comprising at least one red perinone dye to be selected from 8,9,10,11-tetrachloro-12H-phthaloperin-12-one and/or 14H-benz[4,5]isoquino[2,1-a]perimidin-14-one in dissolved form in a photopolymerization-based SLA 3D printer or DLP 3D printer.

By way of clarification, it should be noted that the scope of the present invention encompasses all definitions and parameters mentioned hereinafter in general terms or specified in preferred ranges, in any desired combinations. This likewise relates to the combination of the stated amounts for the individual components in relation to the processes and uses claimed. The standards cited in the context of this application relate to the edition current at the filing date of this invention unless otherwise stated. Percent values are percentages by weight unless otherwise stated.

### Table 1 RAL Colour Chart

In the context of the present invention, red is considered to mean for example a colour that, in the RAL colour system according to https://de.wikipedia.org/wiki/RAL-Farbe#Rot, has a colour number beginning with a “3” in the RAL colour chart. More particularly, at the filing date of the present invention, red hues are distinguished as follows:

| | | L* | a* | b* |
|---|---|---|---|---|
| RAL 3000 | Flame red | 44 | 50 | 39 |
| RAL 3001 | Signal red | 41 | 49 | 33 |
| RAL 3002 | Carmine red | 41 | 49 | 35 |
| RAL 3003 | Ruby red | 36 | 47 | 27 |
| RAL 3004 | Purple red | 31 | 38 | 18 |
| RAL 3005 | Wine red | 26 | 33 | 15 |
| RAL 3007 | Black red | 23 | 17 | 7 |
| RAL 3009 | Oxide red | 29.27 | 24.59 | 16.51 |
| RAL 3011 | Brown red | 34.52 | 28.66 | 13.44 |
| RAL 3012 | Beige red | 63.81 | 20.79 | 20.45 |
| RAL 3013 | Tomato red | 40.70 | 36.67 | 21.37 |
| RAL 3014 | Antique pink | 60.17 | 32.49 | 12.58 |
| RAL 3015 | Light pink | 71.23 | 21.59 | 4.98 |
| RAL 3016 | Coral red | 44.70 | 37.92 | 23.96 |
| RAL 3017 | Rose | 54.24 | 44.26 | 16.87 |
| RAL 3018 | Strawberry red | 50.77 | 49.15 | 19.86 |
| RAL 3020 | Traffic red | 46 | 59 | 54 |
| RAL 3022 | Salmon pink | 56.06 | 38.90 | 29.70 |
| RAL 3024 | Luminous red | 51.32 | 82.52 | 71.62 |
| RAL 3026 | Luminous bright red | 59 | 70 | 59 |
| RAL 3027 | Raspberry red | 43.07 | 46.96 | 15.81 |
| RAL 3028 | Pure red | 51 | 58 | 46 |
| RAL 3031 | Orient red | 46 | 45 | 25 |
| RAL 3032 | Pearl ruby red | 26.88 | 41.34 | 19.40 |
| RAL 3033 | Peal pink | 44.29 | 45.11 | 28.62 |

The table shows the apparatus-independent CIE L*a*b* colour values for the respective RAL values for red: L* stands for luminance, a* describes the colour locus with respect to the red-green axis and b* describes the colour locus with respect to the yellow-blue axis using D65 standard light with a 10° field of view of a standard observer. The colour model is standardized in EN ISO 11664-4 “Colorimetry-Part 4: CIE 1976 L*a*b* Colour space”. For L*a*b* colour space (also: CIELAB) see: https://de.wikipedia.org/wiki/Lab-Farbraum. Each colour in the colour space is defined by a colour locus having the Cartesian coordinates {L*, a*, b*}. The a*b* coordinate plane was constructed using opponent colour theory. Green and red are at opposite ends of the a* axis from one another and the b* axis runs from blue to yellow. Complementary hues are in each case opposite one another at an angle of 180°; all achromatic colours are located in the middle thereof (the coordinate origin a*=0, b*=0).

The L* axis describes the brightness (luminance) of the colour with values of 0 to 100. In the diagram it stands perpendicular to the a*b* plane at the origin. It may also be referred to as the neutral grey axis since all achromatic colours (grey hues) are contained between the endpoints of black (L*=0) and white (L*=100). The a* axis describes the green or red component of a colour, where negative values represent green and positive values represent red. The b* axis describes the blue or yellow component of a colour, where negative values represent blue and positive values represent yellow.

The a* values range from approximately −170 to +100 and the b* values from −100 to +150, the maximum values being achieved only at moderate brightness of certain hues. The CIELAB colour entity has its greatest extent in the region of moderate brightness, but this differs in height and size depending on the colour range.

According to the invention, hues similar to red are however also included, which have a colour distance ΔE<20 from the L*a*b* coordinates for a colour number, beginning with “3”, of the RAL colour chart for the colour red.

### PREFERRED EMBODIMENTS OF THE INVENTION

Preferably, the photopolymerizable urethane-acrylate-resin-based compositions to be employed according to the invention and 3D-printed products to be produced therefrom have a colour distance ΔE<10 from the L*a*b* coordinates for a colour number, beginning with “3”, of the RAL colour chart for the colour red.

Particularly preferably, the photopolymerizable urethane-acrylate-resin-based compositions to be employed according to the invention and 3D-printed products to be produced therefrom have a colour distance ΔE<5 from the L*a*b* coordinates for a colour number, beginning with “3”, of the RAL colour chart for the colour red.

Preferably, the invention relates to 3D-printed products having a colour distance ΔE<20 from the L*a*b* coordinates for a colour number, beginning with “3”, of the RAL colour chart, based on photopolymerizable compositions for the additive manufacture of products by 3D printing, comprising at least one urethane acrylate base resin and, dissolved therein, at least one red perinone dye to be selected from 8,9,10,11-tetrachloro-12H-phthaloperin-12-one and/or 14H-benz[4,5]isoquino[2,1-a]perimidin-14-one.

Preferably, the invention relates to a method for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number, beginning with “3”, of the RAL colour chart, by means of additive manufacturing in 3D printing, by employing at least one red perinone dye to be selected from 8,9,10,11-tetrachloro-12H-phthaloperin-12-one and/or 14H-benz[4,5]isoquino[2,1-a]perimidin-14-one dissolved in the urethane acrylate resin.

Preferably, the invention relates to the use of at least one red perinone dye to be selected from 8,9,10,11-tetrachloro-12H-phthaloperin-12-one and/or 14H-benz[4,5]isoquino[2,1-a]perimidin-14-one, present in dissolved form, for increasing the lightfastness and colouristic properties, to be determined according to DIN EN ISO 4892-2, of photopolymerizable urethane-acrylate-resin-based compositions and 3D-printed products to be generated therefrom having a colour distance ΔE<20 from the L*a*b* coordinates for a colour number, beginning with “3”, of the RAL colour chart, by means of additive manufacturing in 3D printing.

The invention preferably relates to 3D-printed products, to the use according to the invention, and to a method according to the invention for increasing the lightfastness and colouristic properties of 3D-printed products, in which 0.005 to 5 parts by mass of the at least one red perinone dye to be selected from 8,9,10,11-tetrachloro-12H-phthaloperin-12-one and/or 14H-benz[4,5]isoquino[2,1-a]perimidin-14-one are present in dissolved form per 20 to 99.995 parts by mass of urethane-acrylate-based resin, which preferably contains at least one additive. Preferably, the solubility of the red perinone dyes in the urethane-acrylate-based resin according to DIN EN ISO 7579:2010 DE is at least 0.05 g/L at 23° C.

In addition to the at least one red perinone dye it is particularly preferable to employ 0.5-10 parts by mass of a photoinitiator that preferably absorbs in the 300 to 450 nm wavelength range.

In addition to the at least one red perinone dye and the 0.5-10 parts by mass of photoinitiator it is very particularly preferable to employ 0.001-1 parts by mass of at least one additive, preferred additives for the purposes of the present invention being at least one levelling agent, at least one stabilizer, at least one additional dye different from 8,9,10,11-tetrachloro-12H-phthaloperin-12-one or 14H-benz[4,5]isoquino[2,1-a]perimidin-14-one, at least one filler or at least one organic pigment.

### Urethane Acrylate-Based Resins

Photopolymerizable urethane-acrylate-based resins that are preferred according to the invention, particularly for additive manufacturing in 3D printing to be carried out by photopolymerization, are based on polyurethane acrylate [CAS No. 82116-59-4], polyether urethane acrylate or urethane acrylate resins. Reference should be made to WO 2005/028532 A1, RU2546966C1 or M. Alishiri et al., Materials Science and Engineering: C, vol. 42, September 2014, pp. 763-773.

Used in the context of the present invention were and therefore particularly preferred are:
“3D Printing UV Sensitive Resin Clear” from Shenzhen Anycubic Technology Co., Ltd., China; a colourless resin for high-speed light-induced 3D printing containing 30-60% of polyurethane acrylates CAS No. 82116-59-4; 10-40% of isooctyl acrylate CAS No. 29590-42-9; 2-5% of photoinitiator;
“Addigy® LPU Rigid 341-02 IM” from Covestro Deutschland AG, Leverkusen, Germany; a colourless aliphatic polyether urethane acrylate resin for light-induced 3D printing, optimized for high mechanical stress and strength (<25% isobornyl methacrylate CAS 7534-94-3; approx. 10% 4-(1-oxo-2-propenyl) morpholine CAS No. 5117-12-4; <0.15% methacrylic acid CAS No. 79-41-4/2-hydroxyethyl methacrylate CAS No. 868-77-9);
“Ultracur3D® FL 300” from BASF 3D Printing Solutions GmbH, Ludwigshafen, Germany; a colourless reactive urethane acrylate resin for light-induced 3D printing, optimized for high torsional flexibility and high breaking strength (1-3% diphenyl(2,4,6-trimethylbenzoyl) phosphine oxide CAS No. 75980-60-8; 15-20% isodecyl acrylate CAS No. 1330-61-6; 5-10% exo-1,7,7-trimethylbicyclo[2.2.1]hept-2-yl acrylate CAS No. 5888-33-5; 25-50% 3-ethenyl-5-methyl-2-oxazolidinone CAS No. 3395-98-0).

Photopolymerizable resins to be employed according to the invention preferably comprise in addition to the at least one red perinone dye normally a mixture of at least one polymerizable acrylate monomer and/or prepolymer, preferably a (poly) urethane acrylate, at least one photoinitiator and at least one additive. With regard to such additives, reference should in principle be made to WO 2018/038954 A1, the content of which is fully incorporated in the present description. The photoinitiators and additives employable with preference are listed below.

### Photoinitiator

A photoinitiator employable according to the invention is normally characterized by one or more of the following features,
by one or more light absorption bands in the 300 to 450 nm wavelength range and/or a solubility in the curable composition of at least 2 g/l at 23° C.;
a solubility in the radiation-curable components of the curable resin composition and/or in the additive(s) optionally present;
an ability to form a polymerization-reaction-inducing species when exposed to light energy having a wavelength of between 300 and 450 nm, for example by free radicals.

Particular preference according to the invention is given to using at least one photoinitiator from the following group: 2-hydroxy-2-methyl-1-phenylacetone, 1-hydroxycyclohexyl phenyl ketone, 2,4,6-trimethylbenzoyldiphenylphosphine oxide, phenylbis(2,4,6-trimethylbenzoyl) phosphine oxide, ethyl(2,4,6-trimethylbenzoyl)phenylphosphinate.

### Additives

A photopolymerizable resin composition employable according to the invention for 3D printing may preferably comprise at least one additive, stabilizer(s) or mixtures thereof.

In particular, the addition of stabilizer(s) to the curable composition can contribute to improving the resolution and accuracy of the SLA process, by attenuating or preventing undesirable scattering effects, and also to extending the shelf life of the curable composition. Such stabilizers commonly contain a phenol unit. Preference is given to p-methoxyphenol (MOP), hydroquinone monomethyl ether (MEHQ), 2,6-di-tert-butyl-4-methylphenol (BHT; Ionol), phenothiazine, 2,2,6,6-tetramethylpiperidine-1-oxyl (TEMPO) or mixtures thereof. Such stabilizer(s) are preferably used in the following amounts:
Lower amount: at least 0.001%, or at least 0.005%, or at least 0.01%, by weight;
Upper amount: not more than 0.02%, or not more than 0.05%, or not more than 0.5%, or not more than 1%, by weight;
Range: from 0.001% to 1%, or from 0.005% to 0.05%, by weight;
   where % by weight is based on the weight of the curable composition.

### Perinone Dyes

The red perinone dyes to be employed according to the invention, to be selected from 8,9,10,11-tetrachloro-12H-phthaloperin-12-one and/or 14H-benz[4,5]isoquino[2,1-a]perimidin-14-one are characterized by the following features:
molecular weight in the range from 50 to 1000 g/mol
solubility in the urethane-acrylate-based resin composition to be cured and to be used for 3D printing to an extent of at least 0.05 g/L at 23° C.
light absorption maximum in the 400 to 530 nm wavelength range
very good lightfastness in the 3D article
colouristic properties that are highly stable in respect of the curing process
contain at least one perinone unit.

8,9,10,11-Tetrachloro-12H-phthaloperin-12-one is known as Solvent Red 135, CAS No. 20749-68-2 and available from LANXESS Deutschland GmbH, Cologne, Germany.

14H-Benz[4,5]isoquino[2,1-a]perimidin-14-one is known as Solvent Red 179, CAS No. 6829-22-7 and likewise available from LANXESS Deutschland GmbH, Cologne, Germany.

### DIN EN ISO 7579:2010 DE

This international standard specifies two methods for determining the solubility of dyes in organic solvents. They can be employed for dyes that do not change chemically under the influence of the solvent and that are stable and nonvolatile under the specified drying conditions. For low-boiling solvents (lower than 120° C.) a gravimetric process is recommended, and for high-boiling solvents (higher than 120° C.) a photometric process. The method should be selected in accordance with the problem in the particular case. The methods are suitable primarily for concentrations between 1 g and 1000 g of dye per litre of solvent, but can also be used to determine higher solubilities, provided, in the case of the gravimetric method, the viscosity of the test batches does not rise to an extent such that the described homogenization and centrifugation methods fail. The solubility of the at least one red perinone dye to be employed according to the invention in the urethane-acrylate-based resin composition to be cured and to be used for 3D printing is preferably at least 0.05 g/L at 23° C. according to DIN EN ISO 7579:2010 DE.

The method for increasing the lightfastness and colouristic properties, to be determined according to DIN EN ISO 4892-2, of photopolymerizable urethane-acrylate-resin-based compositions is preferably employed in the additive manufacture by photopolymerization of 3D-printed products, preferably in the additive manufacture of 3D-printed products using a photopolymerization-based SLA 3D printer or DLP 3D printer.

In addition, the present invention accordingly also relates to a method for the additive manufacture of 3D-printed products having a colour distance ΔE<20 from the L*a*b* coordinates for a colour number, beginning with “3”, of the RAL colour chart by employing urethane-acrylate-resin-based compositions comprising at least one red perinone dye to be selected from 8,9,10,11-tetrachloro-12H-phthaloperin-12-one and/or 14H-benz[4,5]isoquino[2,1-a]perimidin-14-one in a photopolymerization-based SLA 3D printer or DLP 3D printer.

It will be understood that the specification and examples are illustrative but not limitative of the present invention and that other embodiments within the spirit and scope of the invention will suggest themselves to those skilled in the art.

### Examples

### Method for Determining the Lightfastness of Dyes in 3D Printing

For determination of the lightfastness of dyes in 3D printing, test specimens made of coloured resin having a dye concentration of 0.02% by weight in the resin were produced for the purposes of the present invention. As test specimen, a cuboid having the following dimensions was produced from coloured resin by 3D printing.

| | |
|---|---|
| Length | 60 mm |
| Width | 40 mm |
| Height | 2 mm |

The test specimens were exposed to light (xenon lamp) for 95-100 h according to DIN EN ISO 4892-2 using a Xenotest Beta+device (Atlas Material Testing Technology GmbH, Linsengericht-Altenhaßlau, Germany).

Lightfastness was evaluated colourimetrically. This was done using the X-Rite Ci7800 sphere spectrophotometer (X-Rite GmbH, Planegg-Martinsried, Germany) to record transmission spectra of the light-exposed test specimens. The following settings were chosen for this:

| Measurement geometry | d/8° | |
|---|---|---|
| Spectral interval | 10 | nm |
| Spectral range | 360-750 | nm |

From the transmission spectra, the manufacturer's software for the sphere spectrophotometer calculated the colorimetric data with the following settings:

| | |
|---|---|
| Light source/observer | D65/10° |
| Colour space | L*a*b*C*h° |

The basis for the evaluation of lightfastness was the colour distances ΔE in the L*a*b*C*h° colour space between light-exposed test specimens and the corresponding unexposed test specimen. The greater the colour distance and thus ΔE, the greater the change in colour impression brought about by the influence of exposure to light and thus the poorer the lightfastness. AE was classified on the basis of a comparison with noninventive red dyes (see noninventive examples) for which the lightfastness in other uses (for example the bulk colouring of plastics) is generally evaluated as good according to the manufacturer's data.

TABLE 2
Evaluation of lightfastness

| ΔE after exposure to | | |
|---|---|---|
| light in % * | Evaluation | Abbreviation |
| ≤10 | Excellent | A |
| >10-25 | Very good | B |
| >25-50 | Satisfactory | C |
| >50-100 | Moderate to inadequate | D |

* compared with the average ΔE of the noninventive examples

### Method for Evaluating the Stability of Colouristic Properties

In order to ascertain the change in the spectral properties that determine the colouristic properties of a dye, the absorption spectra before and after light-induced curing of the coloured resins were compared.

The coloured resins produced as described previously were transferred to a quartz glass cuvette 1 cm in width. Absorption spectra in transmission mode were then recorded with the X-Rite Ci7800 instrument (X-Rite GmbH, Planegg-Martinsried, Germany) in the 360 to 750 nm wavelength range. These were corrected for the absorbance of the corresponding uncoloured resin by performing the same measurement with the uncoloured resin. In analogous manner, the absorption spectra in transmission mode of the coloured test specimens were recorded and corrected. The spectra were in each case normalized to the path length of the cuvette/test specimen.

The similarity of the absorption spectra before and after 3D printing was then calculated from the measured data. This was done by calculating the correlation coefficient R of the normalized absorption (spectral interval 10 nm). The greater the value for R, the greater the similarity of the absorption spectra and thus the more stable the colouristic properties of a dye in 3D printing.

TABLE 3
Evaluation of stability/preservation of colouristic properties

| R | Evaluation | Abbreviation |
|---|---|---|
| 0.9-1 | Excellent preservation | A |
| 0.7-<0.9 | Good preservation | B |
| 0.6-<0.7 | Largely preserved | C |
| 0-<0.6 | Noticeable colour deviation, inadequate | D |

The coloured 3D prints were produced and tested according to the methods described above in three resin compositions having different properties (see Materials). In resin composition 1, dye mixtures were additionally investigated by way of example.

TABLE 4
Inventive examples of red perinone dyes in resin composition 1

| | | Evaluation of | | Evaluation |
|---|---|---|---|---|
| Dye | ΔE in % | exposure to light | R | of R |
| Solvent Red 135 | 3.4 | A | 0.72 | B |
| Solvent Red 179 | 2.3 | A | 0.90 | A |

TABLE 5
Noninventive examples of various red dyes in resin composition 1

| | | Evaluation of | | Evaluation |
|---|---|---|---|---|
| Dye | ΔE in % | exposure to light | R | of R |
| Solvent Red 52 | 30.2 | D | <0.01 | D |
| Solvent Red 149 | 34.7 | D | <0.01 | D |
| Solvent Red 23 | 43.4 | D | 0.71 | B |

TABLE 6
Inventive examples of red perinone dyes in resin composition 2

| | | Evaluation of | | Evaluation |
|---|---|---|---|---|
| Dye | ΔE in % | exposure to light | R | of R |
| Solvent Red 135 | 3.1 | A | 0.89 | B |
| Solvent Red 179 | 2.7 | A | 0.90 | A |

TABLE 7
Noninventive examples of various red dyes in resin composition 2

| | | Evaluation of | | Evaluation |
|---|---|---|---|---|
| Dye | ΔE in % | exposure to light | R | of R |
| Solvent Red 52 | 31.0 | C | 0.21 | D |
| Solvent Red 149 | 37.3 | C | 0.16 | D |
| Solvent Red 23 | 39.8 | C | 0.67 | C |

TABLE 8
Inventive examples of red perinone dyes in resin composition 3

| | | Evaluation of | | Evaluation |
|---|---|---|---|---|
| Dye | ΔE in % | exposure to light | R | of R |
| Solvent Red 135 | 3.5 | A | 0.83 | B |
| Solvent Red 179 | 1.8 | A | 0.91 | A |

TABLE 9
Noninventive examples of various dyes in resin composition 3

| | | Evaluation of | | Evaluation |
|---|---|---|---|---|
| Dye | ΔE in % | exposure to light | R | of R |
| Solvent Red 52 | 29.4 | C | 0.25 | D |
| Solvent Red 149 | 31.2 | C | 0.13 | D |
| Solvent Red 23 | 39.7 | C | 0.73 | B |

### Reactants

TABLE 9
Materials used and sources of supply

| Material | Description | Source |
|---|---|---|
| 3D Printing UV | Colourless resin for high-speed, light-induced 3D | Shenzhen |
| Sensitive Resin Clear | printing | Anycubic |
| (designated resin | (30-60% polyurethane acrylates CAS 82116-59-4; | Technology Co., |
| composition 1) | 10-40% isooctyl acrylate CAS 29590-5-9; 2-42% | Ltd. |
| | photoinitiator) | |
| Addigy ® LPU Rigid | Colourless aliphatic polyether urethane acrylate | Covestro |
| 341-02 IM | resin for light-induced 3D printing, optimized for | Deutschland AG |
| (designated resin | high mechanical stress and strength | |
| composition 2) | (<25% isobornyl methacrylate CAS 7534-94-3; | |
| | approx. 10% 4-(1-oxo-2-propenyl)morpholine CAS | |
| | 5117-12-4; <0.15% methacrylic acid CAS 79-41-4/ | |
| | 2-hydroxyethyl methacrylate CAS 868-77-9) | |
| Ultracur3D ® FL 300 | Colourless reactive urethane acrylate resin for light- | BASF 3D |
| (designated resin | induced 3D printing, optimized for high torsional | Printing |
| composition 3) | flexibility and high breaking strength | Solutions GmbH |
| | (1-3% diphenyl(2,4,6-trimethylbenzoyl)phosphine | |
| | oxide CAS 75980-60-8; 15-20% isodecyl acrylate | |
| | CAS 1330-61-6; 5-10% exo-1,7,7- | |
| | trimethylbicyclo[2.2.1]hept-2-yl acrylate CAS 5888- | |
| | 33-5; 25-50% 3-ethenyl-5-methyl-2-oxazolidinone | |
| | CAS 3395-98-0) | |
| 8,9,10,11-Tetrachloro- | Perinone dye, C.I. Solvent Red 135, CAS No. | Lanxess |
| 12H-phthaloperin-12- | 20749-68-2 | Deutschland |
| one | | GmbH |
| 14H- | Perinone dye, C.I. Solvent Red 179, CAS No. 6829- | Lanxess |
| Benz[4,5]isoquino[2,1- | 22-7 | Deutschland |
| a]perimidin-14-one | | GmbH |
| 6-(Cyclohexylamino)- | Anthraquinone dye, C.I. Solvent Red 149, CAS No. | Alfa Chemistry |
| 3-methyl-3H- | 71902-18-6 | |
| dibenz[f,ij]isoquinoline- | | |
| 2,7-dione | | |
| 3-Methyl-6-(p- | Anthraquinone dye, C.I. Solvent Red 52, CAS No. | abcr GmbH |
| toluidino)-3H- | 81-39-0 | |
| dibenz[f,ij]isoquinoline- | | |
| 2,7-dione | | |
| 1-[[p- | Azo dye, C.I. Solvent Red 23, CAS No. 85-86-9 | Haining Hongyu |
| Phenylazo]phenyl]azo- | | Chemical Co., |
| 2-naphthol | | Ltd |

1. A 3D-printed product having a colour distance ΔE<20 from the L*a*b* coordinates for a colour number, beginning with “3”, of the RAL colour chart, based on photopolymerizable compositions comprising at least one urethane acrylate resin and, dissolved therein, at least one red perinone dye to be selected from 8,9,10,11-tetrachloro-12H-phthaloperin-12-one and/or 14H-benz[4,5]isoquino[2,1-a]perimidin-14-one.

2. The 3D-printed product according to claim 1, wherein the at least one urethane acrylate resin is based on urethane acrylate, polyurethane acrylate or polyether urethane acrylate.

3. The 3D-printed product according to claim 1, wherein 0.005 to 5 parts by mass of the at least one red perinone dye are used per 20 to 99.995 parts by mass of the at least one urethane-acrylate-based resin.

4. The 3D-printed product according to claim 3, wherein in addition to the at least one red perinone dye, 0.5-10 parts by mass of photoinitiator are employed.

5. The 3D-printed product according to claim 4, wherein the photoinitiator absorbs in the 300 to 450 nm wavelength range.

6. The 3D-printed product according to claim 4, wherein in addition to the at least one red perinone dye and the 0.5-10 parts by mass of photoinitiator, 0.001-1 parts by mass of at least one additive are employed.

7. The 3D-printed product according to claim 6, wherein the at least one additive is a levelling agent, a stabilizer, an additional dye different from the red perinone dye, a filler or an organic pigment.

8. A The 3D-printed product according to of claim 1, prepared using a SLA 3D printer or a DLP 3D printer.

9. A process for additive manufacturing of 3D-printed products having a colour distance ΔE<20 from the L*a*b* coordinates for a colour number, beginning with “3”, of the RAL colour chart comprising dissolving in an urethane-acrylate-based resin composition at least one red perinone dye selected from 8,9,10,11-tetrachloro-12H-phthaloperin-12-one and/or 14H-benz[4,5]isoquino[2,1-a]perimidin-14-one.

10. The Process according to claim 9, wherein the at least one perinone dye is provided in a photopolymerization-based 3D printing.

11. The process according to claim 9, wherein the urethane-acrylate-resin-based compositions are based on urethane acrylate, on polyurethane acrylate or on polyether urethane acrylate.

12. A method for increasing the lightfastness and coloristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number, beginning with “3”, of the RAL colour chart, comprising dissolving at least one red perinone dye to be selected from 8,9,10,11-tetrachloro-12H-phthaloperin-12-one and/or 14H-benz[4,5]isoquino[2,1-a]perimidin-14-one in an urethane-acrylate-resin-based composition.

13. The method according to claim 12, wherein the increasing of lightfastness and coloristic properties takes place in the additive manufacture of 3D-printed products.

14. The method according to claim 13, wherein the additive manufacture is a photopolymerization-based 3D printing process.

15. The method according to claim 12, wherein the urethane-acrylate-resin-based composition is based on urethane acrylate, on polyurethane acrylate or on polyether urethane acrylate.
